(19) United States
(12) Patent Application Publication
(10) Pub. No.: US 2013/0316264 A1
(43) Pub. Date: Nov. 28, 2013

(54) FUNCTIONALLY LAYERED ELECTROLYTE FOR SOLID OXIDE FUEL CELLS

(71) Applicants: Ying Liu, Bartlesville, OK (US); Ting He, Bartlesville, OK (US)

(72) Inventors: Ying Liu, Bartlesville, OK (US); Ting He, Bartlesville, OK (US)

(73) Assignee: Phillips 66 Company, Houston, TX (US)

(21) Appl. No.: 13/893,957

(22) Filed: May 14, 2013

Related U.S. Application Data
(60) Provisional application No. 61/651,316, filed on May 24, 2012.

(51) Int. Cl. H01M 8/10

(52) U.S. Cl. CPC H01M 8/1016
USPC 429/482; 429/535

(57) ABSTRACT

A process of spraying a first electrolyte mixture onto an anode substrate followed by spraying a second electrolyte mixture onto the first electrolyte. The first electrolyte mixture comprises a first solvent and a first electrolyte and the second electrolyte mixture comprises a second solvent and a second electrolyte.

### CROSS-REFERENCE TO RELATED APPLICATIONS

This application is a non-provisional application which claims the benefit of and priority to U.S. Provisional Application Ser. No. 61/651,316 filed May 24, 2012, entitled “Functionally Layered Electrolyte for Solid Oxide Fuel Cells,” which is hereby incorporated by reference in its entirety.

### STATEMENT REGARDING FEDERALLY SPONSORED RESEARCH OR DEVELOPMENT

None.

### FIELD OF THE INVENTION

This invention relates to creating layered electrolyte for solid oxide fuel cells,

### BACKGROUND OF THE INVENTION

A solid oxide fuel cell is an electrochemical conversion device that produces electricity directly from oxidizing a fuel. Solid oxide fuel cells are characterized by their electrolyte material. Advantages of this class of fuel cells include high efficiency, long-term stability, fuel flexibility and low emissions.

A solid oxide fuel cell is typically made up of three layers: a cathode, an anode and an electrolyte sandwiched between the cathode and anode. The cathode is commonly a thin porous layer on the electrolyte where oxygen reduction takes place. The anode is commonly a porous layer that allows the fuel to flow towards the electrolyte. The anode is commonly the thickest and strongest layer in each individual cell, because it has the smallest polarization losses, and is often the layer that provides the mechanical support. The electrolyte is commonly a dense layer that conducts either oxygen ions and/or protons. Typically, its electronic conductivity must be kept as low as possible to prevent losses from leakage currents.

### BRIEF SUMMARY OF THE DISCLOSURE

A process of spraying a first electrolyte mixture onto an anode substrate followed by spraying a second electrolyte mixture onto the first electrolyte. The first electrolyte mixture comprises a first solvent and a first electrolyte and the second electrolyte mixture comprises a second solvent and a second electrolyte.

In yet another embodiment the present disclosure describes a process of spraying a first electrolyte mixture comprising a first solvent and a first electrolyte, onto one side of an anode substrate. This is followed by heating the anode substrate to evaporate the first solvent leaving a layer of the first electrolyte onto the anode substrate, ranging from 1.0 μm to 30.0 μm in thickness. A second electrolyte mixture is then sprayed onto the first electrolyte, wherein the second electrolyte mixture comprises a second solvent and a second electrolyte. This is then followed by heating the anode substrate to evaporate the second solvent, leaving a layer of the second electrolyte on top of the first electrolyte on top of the anode substrate. The thickness of the second electrolyte layer ranges from 1.0 μm to 30.0 μm.

The present disclosure also describes a solid oxide fuel cell. The solid oxide fuel cell comprises an anode substrate, a cathode substrate and a multilayer electrolyte situated between the anode substrate and the cathode substrate. The multilayer electrolyte is formed by individually spraying at least two electrolyte mixtures.

In yet another embodiment the present disclosure also describes a solid oxide fuel cell. The solid oxide fuel cell comprises an anode substrate, a cathode substrate and a multilayer electrolyte situated between the anode substrate and the cathode substrate. The multilayer electrolyte is formed by individually spraying at least two electrolyte mixtures. In this embodiment each layer in the multilayer electrolyte ranges form 1.0 μm to 30.0 μm and is evenly distributed.

### BRIEF DESCRIPTION OF THE DRAWINGS

A more complete understanding of the present invention and benefits thereof may be acquired by referring to the follow description taken in conjunction with the accompanying drawings in which:

FIG. 1a depicts a sprayer that can be positioned vertically perpendicular to the anode substrate 1. FIG. 1b depicts the table for securing the anode substrate.

FIG. 2 depicts the difference between a single electrolyte and a bi-layer electrolyte solid oxide fuel cell.

FIG. 3 depicts the ionic conductivity of electrolytes.

FIG. 4 depicts electrochemical performance of cells with single layer and bi-layer electrolytes.

FIG. 5a depicts 1 coat with multiple cracks. FIG. 5b depicts 2 coats with one crack. FIG. 5c depicts 3 coats with no cracks.

FIG. 6a depicts, 1 coat with no cracks. FIG. 6b depicts 2 coats with some cracks. FIG. 6c depicts 3 coats with multiple cracks.

FIG. 7a depicts a flow rate of 3.0 ml/min. FIG. 7b depicts a flow rate of 1.5 mL/min. FIG. 7c depicts a flow rate of 1.0 mL/min. FIG. 7d depicts a flow rate of 0.5 mL/min.

### DETAILED DESCRIPTION

Turning now to the detailed description of the arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

The present disclosure describes a process of spraying a first electrolyte mixture onto an anode substrate. This is followed by spraying a second electrolyte mixture onto the first electrolyte. In this embodiment the first electrolyte mixture comprises a first solvent and a first electrolyte and the second electrolyte mixture comprises a second solvent and a second electrolyte.

In yet another embodiment the present disclosure describes a process of spraying a first electrolyte comprising a first solvent and a first electrolyte onto one side of the anode substrate. The anode substrate is then heated to evaporate the first solvent leaving a layer ranging from 1.0 μm to 30.0 μm of the first electrolyte onto the anode substrate. A second electrolyte mixture comprising a second solvent and a second electrolyte is then sprayed onto the first electrolyte. The anode substrate is then heated to evaporate the second solvent leaving a layer, ranging from 1.0 μm to 30.0 μm, of the second electrolyte on top of the first electrolyte on top of the anode substrate.

The anode substrate can be any known substrate capable of operating as an anode in a solid oxide fuel cell. Electrochemically, the anode is responsible for using the oxygen ions that diffuse through the electrolyte to oxide the hydrogen fuel. In one embodiment the thickness of the anode can vary between 5.0 μm to 100 μm, 5.0 μm to 500 μm or 30 μm to 60 μm, 30 μm to 100 μm or even 100 μm to 300 μm.

The electrolyte mixtures comprise a solvent and an electrolyte. The ratio of solvent and electrolyte in the electrolyte mixture is dependent upon the type of solvent and electrolyte used. It is important that the mixture of the electrolyte mixture is heterogeneous in mixture wherein there is a distinct phase difference between the liquid solvent and the solid electrolyte. Examples of the amount of electrolyte possible in the electrolyte mixture can be anywhere from 5 wt % to 40 wt %, 10 wt % to 30 wt %, 30 wt % to 70 wt % or even 40 wt % to 60 wt %.

In one embodiment different types of chemical additives outside or the solvent and electrolyte can be added to the electrolyte mixture to improve the stability and quality of the electrolyte mixture. Different types of chemicals that can be added to the electrolyte mixture include binders, plasticizers, dispersants and surfactants. Different types of binders include vinyl (e.g. polyvinyl alcohol, polyvinyl butyral, and polyvinyl chloride), acrylics (e.g. polyacrylate esters, polymethyl methacrylate, and polyethyl methacrylate), and celluloses (e.g. nitrocellulose, methyl cellulose, and ethyl cellulose). Different types of plasticizers include phthalates (e.g. n-Butyl (dibutyl), dioctyl, butyl benzyl, and dimethyl) and glycols (e.g. (poly)ethylene, polyalkylene, (poly)propylene, triethylene, and dipropylglycol dibenzoate). Different types of dispersants or surfactants that can be used include fish oils, citric acid, stearic acid, corn oil, and terpineols.

Different types of solvents can be used. Solvents that can be utilized include those that evaporate at temperatures above room temperature but below intense heating temperatures. This allows one skilled in the art to easily evaporate the solvent while leaving a layer of electrolyte on an anode substrate. In one embodiment the evaporation temperature of the solvent is at least 30° C., 40° C., 50° C., 60° C., 70° C., even I0° C. The solvent can either be water, water based or alcohols. Different types of alcohols that can be utilized include: ethanol, isopropanol, methyl ethyl ketone (MEK), toluene, methanol, butanol, xylenes, and acetone. It is important to note that the solvent can comprise of different solvents used in combination to achieve an ideal solvent capable of being easily evaporated to leave a layer of electrolyte on an anode substrate.

Electrolyte materials that can be used include those that are commonly known in the art to conduct either oxygen ions and/or protons. Types of electrolytes typically used include the group comprising; stabilized zirconia, doped ceria, stabilized bismuth sesquioxide and perovskite structured electrolytes. For example, stabilized zirconia electrolytes include ZrO₂—Me₂O₃ where Me can be rare-earth metals such as Y, Sm, Nd, Yb, and Sc. Doped ceria electrolytes can include CeO₂—Me₂O₃ where Me can be rare-earth metals such as La, Y, Gd and Sm. Stabilized bismuth sesquioxide electrolytes can include Bi₂O₃—Me₂O₃ where Me can be a rare-earth metal such as Dy, Er, Y, Gd, Nd, and La. Perovskite structured electrolytes can include: LaMeGaLnO₃, where both Me and Ln can be different types of group 2 elements such as Sr, Ca, Mg and BaZrMe where Me can be group 3 or lanthanoid elements such as Y, Yb or Sc; and BaZrCeMe where Me can be group 3 or lanthanoid elements such as Y, Yb or Sc. Specific types of popular electrolytes include yttria stabilized zirconia, scandia stabilized zirconia and gadolinium doped ceria.

To ensuic that there are at least two layers of electrolyte on the anode substrate the selection of the electrolyte materials are chosen so that the first electrolyte and the second electrolyte are different. The selection of the first solvent and the second solvent can be the same or different.

The spraying of the electrolyte mixtures on the anode substrate is done at a rate and speed to ensure that the thickness of the electrolyte after the evaporation of the solvent ranges from 1.0 μm to 30.0 μm. In another embodiment the thickness of the electrolyte ranges from 1.0 μm to 15.0 μm, 1.0 μm to 10.0 μm, even 2.0 μm to 5.0 μm.

The thickness of the electrolyte mixtures can be controlled by a combination of different parameters. Some of these parameters include electrolyte concentrations (amount of electrolyte in the mixture), travel speed of the spray head, distance between the spray head and the anode substrate, and flow rate. The flow rate of spraying the electrolyte mixture can be dependent on multiple factors. In one embodiment the flow rate can be 25 mL/min. In other embodiments the flow rate can be less than 20 mL/min, 15 mL/min, 10 mL/min, 7.5 mL/min, 5 mL/min, 2.5 mL/min, 1.5 mL/min, 1.0 mL/min even 0.5 mL/min.

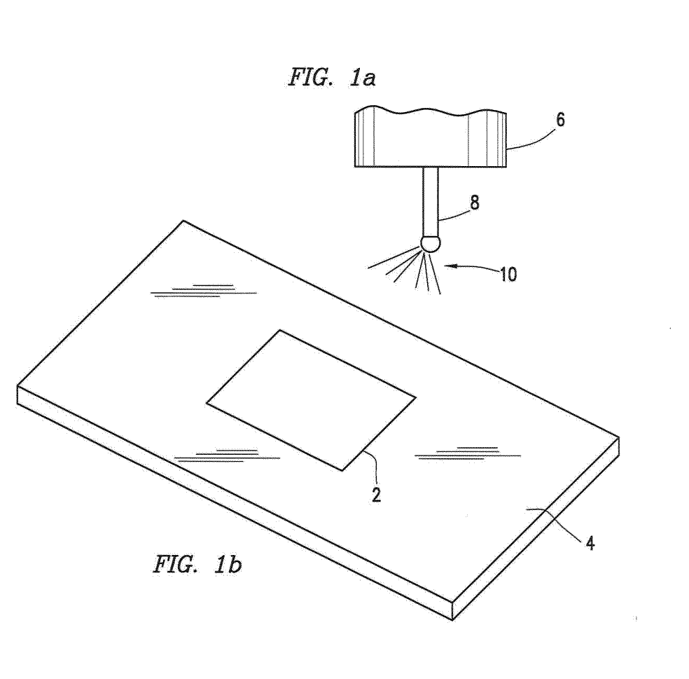

One of the methods used to ensure the even thickness of the electrolyte layer on the anode substrate is to spray the electrolyte mixtures from a position perpendicular to the anode substrate. This is demonstrated in FIG. 1.

FIG. 1b, the anode substrate 2 is placed on top of a table 4. The anode substrate can be secured to the table using any known method to prevent any movement during the spraying process, as depicted in FIG. 1b. As shown in FIG. 1a, the sprayer 6 can be positioned vertically perpendicular to the anode substrate 2. The spray head 8 of the sprayer 6 sprays the electrolyte mixture 10 onto the anode substrate 2 while horizontally moving to ensure even coating of the electrolyte mixture onto the anode substrate.

After spraying of the electrolyte mixture the anode substrate is kept and dried in a horizontal position. By keeping the anode substrate and the electrolyte mixture in a horizontal position it ensures that no one side or corner of the anode substrate would have a thicker layer of electrolyte due to movement of the aqueous electrolyte mixture. Each electrolyte mixture sprayed onto the anode substrate can be dried in this manner. In one embodiment the variance between all four sides and corners is less than 15%, 10% even 5%.

The environmental temperature conditions in which the electrolyte mixture is sprayed can be any temperature below the evaporation temperature of the solvent to the freezing point of the solvent. In one embodiment the environmental temperature is kept at a range from 10° C. to 80° C., or even from 10° C. to 70° C., 10° C. to 60° C., 10° C. to 50° C., 10° C. to 40° C., even 10° C. to 30° C. By keeping the environmental temperature conditions in which the electrolyte mixture is sprayed below the evaporation temperature of the solvent to the freezing point of the solvent it ensures that the electrolyte mixture is kept in an aqueous slurry solution and not gaseous, plasma or solid.

In one embodiment a solid oxide fuel cell is created comprising an anode substrate, a cathode substrate and a multilayer electrolyte, formed by individually spraying at least two electrolyte mixtures, situated between the anode substrate and the cathode substrate.

The cathode substrate can be any known substrate capable of operating as a cathode in a solid oxide fuel cell. The formation of the cathode substrate can be formed by any currently known method. In one embodiment the thickness of the cathode can vary between 5.0 μm to 100 μm or even 30 μm to 60 μm.

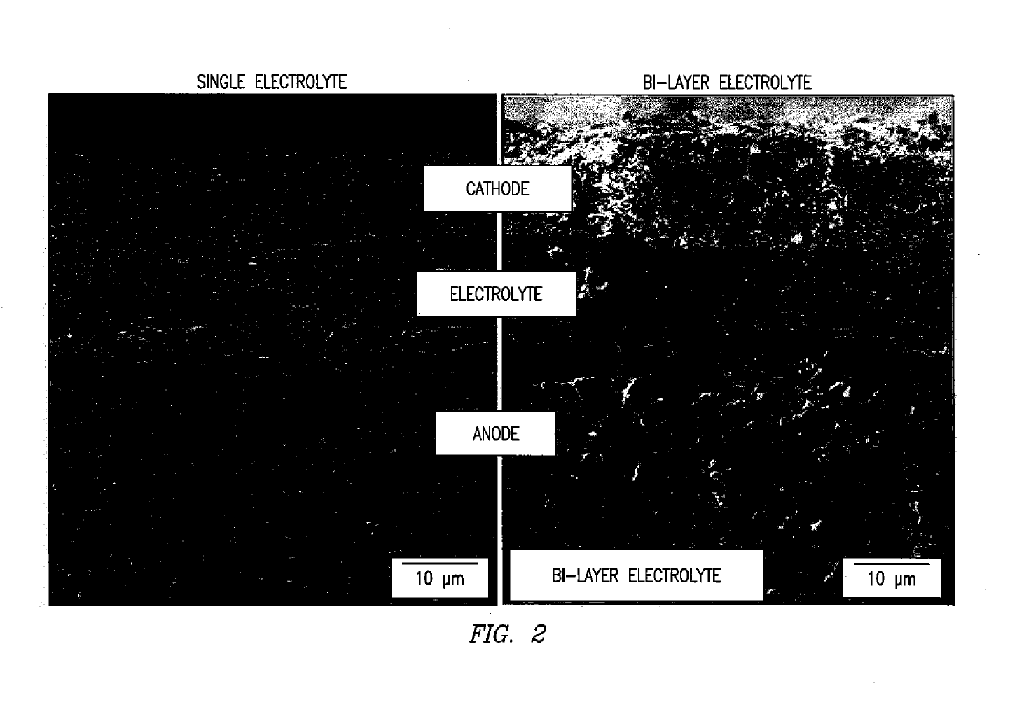

As shown in FIG. 2, a comparison is made between a single layer electrolyte solid oxide fuel cell and a bi-layer electrolyte solid oxide fuel cell. In one embodiment it is feasible that the electrolyte layer comprises 3 layers, 4 layers or even more.

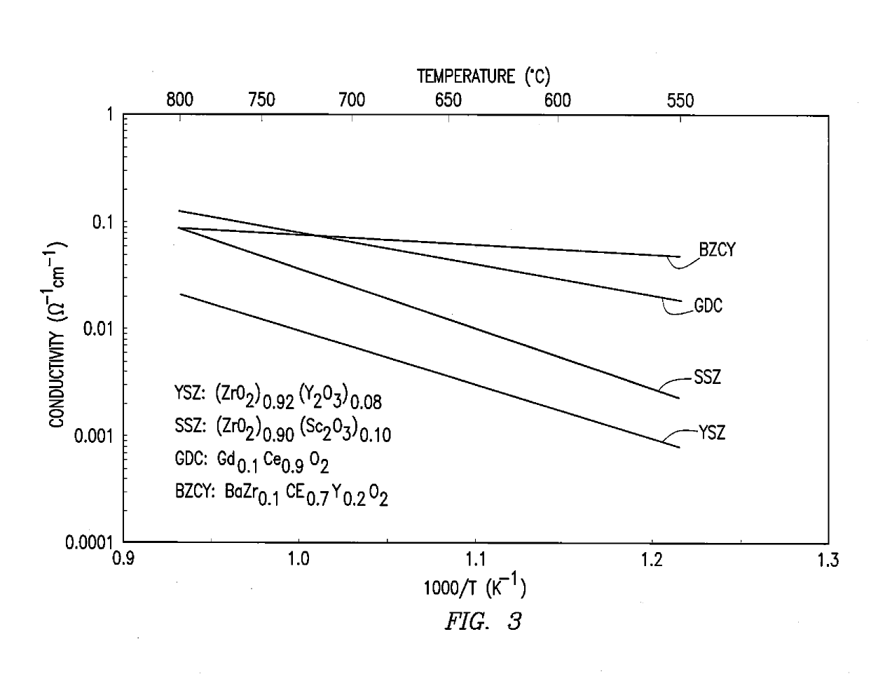

As shown in FIG. 3, the ionic conductivity of electrolytes varies by temperature range. Under fuel cell operating conditions, some of the electrolyte materials exhibited stability issues such as decomposition and development of electronic conductivity which leads to internal shortage. By having different electrolytes it would be possible to fabricate a solid oxide fuel cell that outperforms single layer electrolyte solid oxide fuel cells. It is theorized that by using multiple electrolytes one of the electrolytes can operate as a blocking layer, which prevents the highly conductive primary electrolyte from directly contacting the fuel or oxidant gas.

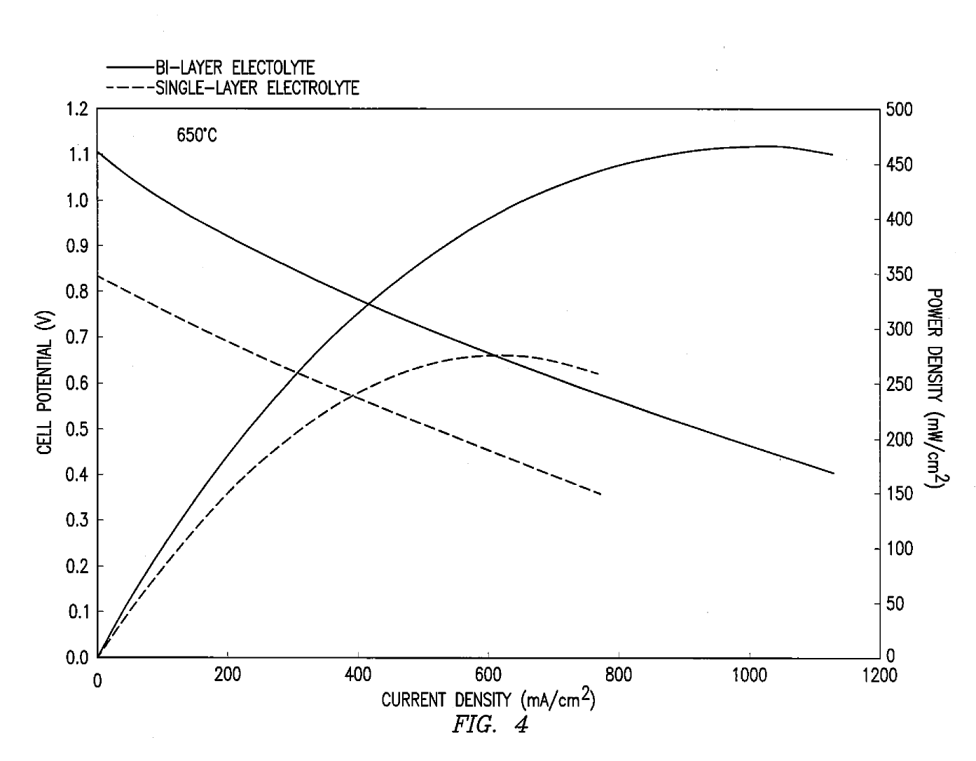

This is shown in FIG. 4 where single layer electrolyte cell only gives an open circuit voltage (OCV) of 0.85V (vs. 1.128V theoretical value at the operating conditions) due to leakage current. The OCV is improved to 1.11V by applying additional blocking electrolyte layer. As a result, peak power density is improved from 260 mW/cm² to 465 mW/cm².

In one embodiment prior to placing the cathode layer on top of the electrolyte mixture the electrolyte surface was sintered at a temperature ranging from 1,300° C. to 1,600° C. for a period of time ranging from 3 hours to 8 hours.

### EXAMPLES

A supporting anode substrate was fabricated by conventional tape casting techniques. In this example an appropriate amount of NiO and Sm_{0.2}Ce_{0.8}O₂ was mixed with different binder, dispersant and plasticizer chemical additives on a jar mill. This homogenized ceramic slurry was then tape casted into the appropriate size.

Three different electrolyte mixtures were prepared by mixing Ce_{0.8}Sm_{0.2}O_{1.9} (50 wt %) with isopropanol (3.5 wt %) and terpineol (15 wt %) on a jar mill for 24 hours. Spraying was carried out by using a Prism 300 ultrasonic spray coater manufactured by Ultrasonic Systems, Inc. Prior to coating, the ceramic slurry was loaded into a specially designed 100 mL glass syringe that was mechanically supported by a metallic holder. The movement of the syringe was driven by a computer-controlled electric motor. A magnetic stirring bar was placed inside the syringe to prevent the settling of the electrolytes in the electrolyte mixture.

The ceramic slurry was conveyed through a ⅛ inch diameter palytetrafluororthylene tubing to the spray head, Where it was atomized into a fine mist by an ultrasonic vibrator. The computer-controlled spraying head was able to move in the X, Y, and Z directions.

### Film Quality As A Result of Multilayer Electrolytes

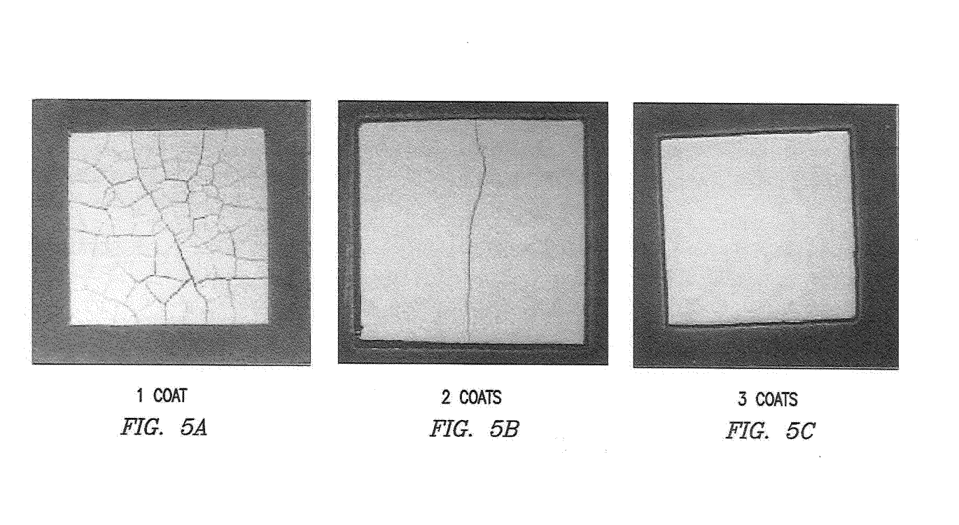

The flow rate of the spray head was set at a constant rate of 3.0 mL/min. The sample holder was kept at 40° C. during this spraying. Three tests were done spraying one layer, two layers and three layers. As shown in FIGS. 5a, 5b and 5c, the amount of layers has a significant influence on parameters such as cracking. At three layers no cracking was shown in the electrolyte layer. FIG. 5a depicts 1 coat with multiple cracks, FIG. 5b depicts 2 coats with one crack and FIG. 5c depicts 3 coats with no cracks in the electrolyte layer.

### EFFECT OF SOLVENT

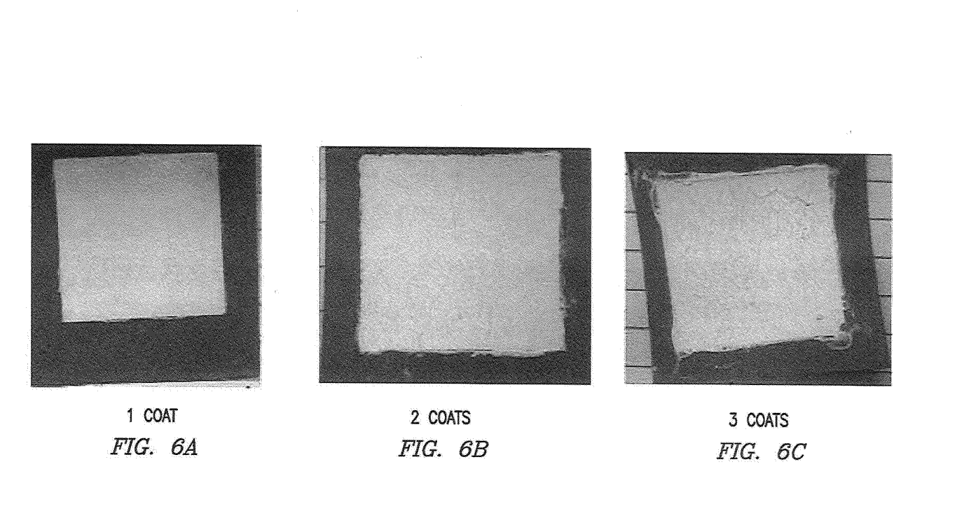

An electrolyte mixture was prepared similar to the one above with Ce_{0.8}Sm_{0.2}O_{1.9} (50 wt %) and water (50 wt %) instead of alcohol. As shown in FIGS. 6a, 6b and 6c, each successive layer demonstrated cracking. FIG. 6a depicts 1 coat with no cracks, FIG. 6b depicts 2 coats with some cracks and FIG. 6c depicts 3 coats with multiple cracks. It is theorized that this occurred due to the high surface tension.

### Effect of Flowrate

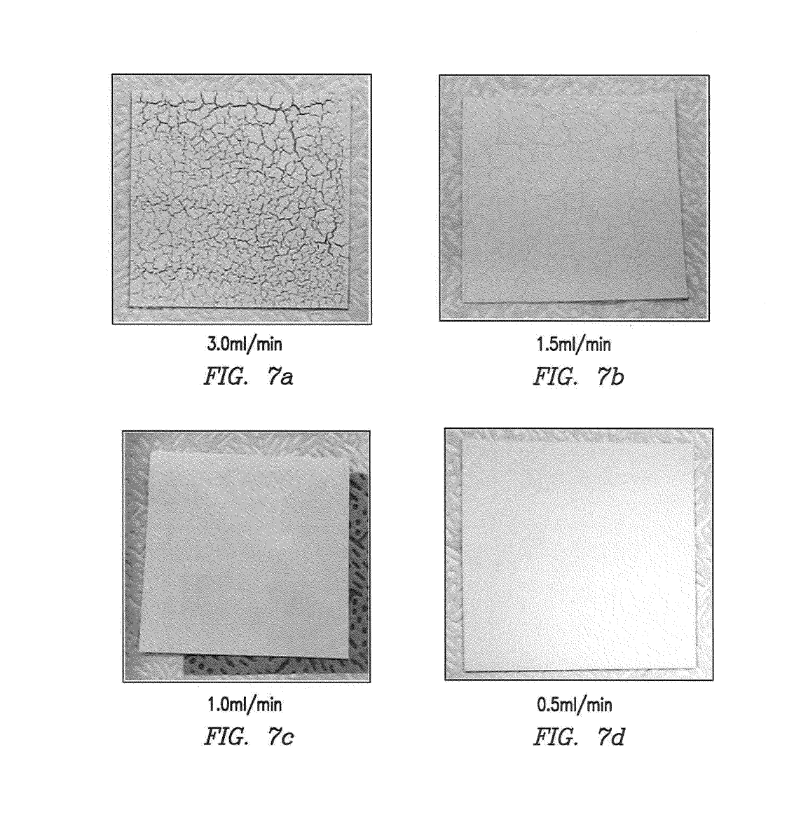

Flow rate of the electrolyte mixture was varied from 0.5 to 3.0 mL/min. Spraying time was also changed correspondingly to keep the amount of mixture deposited on the substrates constant. As shown in FIGS. 7a, 7b, 7c and 7d, a flow rate of 3.0 mL/min promoted cracking. FIG. 7a depicts a flow rate of 3.0 mL/min, FIG. 7b depicts a flow rate of 1.5 mL/min, FIG. 7c depicts a flow rate of 1.0 mL/min and FIG. 7d depicts a flow rate of 0.5 mL/min.

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiment of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A process comprising:
spraying a first electrolyte mixture onto an anode substrate; and
spraying, a second electrolyte mixture onto the first electrolyte,
wherein the first electrolyte mixture comprises a first solvent and a first electrolyte and the second electrolyte mixture comprises a second solvent and a second electrolyte.

2. The process of claim 1, wherein the first solvent and the second solvent is an alcohol.

3. The process of claim 1, wherein the first electrolyte and the second electrolyte is selected from the group consisting of: stabilized zirconia, doped ceria, stabilized bismuth sesquioxide and perovskite structured electrolytes.

4. The process of claim 1, wherein the first electrolyte and the second electrolyte are different.

5. The process of claim 1, wherein the anode substrate is heated after the spraying of the first electrolyte to evaporate the first solvent leaving a layer of the first eJectrolyte onto the anode substrate.

6. The process of claim 5, wherein the thickness of the first electrolyte ranges from 1.0 μm to 30.0 μm.

7. The process of claim 1, wherein the anode substrate is heated after the spraying of the second electrolyte to evaporate the second solvent leaving a layer of the second electrolyte on top of the lust electrolyte on top of the anode substrate.

8. The process of claim 5, wherein the layer of the first electrolyte is evenly distributed on the anode substrate.

9. The process of claim 7, wherein, the layer of the second electrolyte is evenly distributed on top of the first electrolyte.

10. A process comprising:
spraying a first electrolyte mixture comprising: a first solvent and a first electrolyte, onto one side of an anode substrate;
heating the anode substrate to evaporate the first solvent leaving a layer, ranging from 1.0 μm to 30.0 μm, of the first electrolyte onto the anode substrate;
spraying a second electrolyte mixture comprising: a second solvent and a second electrolyte, onto the first electrolyte; and
heating the anode substrate to evaporate the second solvent leaving a layer, ranging from 1.0 μm to 30.0 μm, of the second electrolyte on top of the first electrolyte on top of the anode substrate.

11. A solid oxide fuel cell comprising:
an anode substrate;
a cathode substrate; and
a multilayer electrolyte, formed by individually spraying at least two electrolyte mixtures, situated between the anode substrate and the cathode substrate.

12. The solid oxide fuel cell of claim 11, wherein the electrolyte mixtures comprise a solvent and an electrolyte.

13. The solid oxide fuel cell of claim 11, wherein each layer in the multilayer electrolyte ranges from 1.0 μm to 30.0 μm.

14. The solid oxide fuel cell of claim 11, wherein each layer of the multilayer electrolyte is evenly distributed.

15. A solid oxide fuel cell comprising:
an anode substrate;
a cathode substrate; and
a multilayer electrolyte, formed by individually spraying at least two electrolyte mixtures, situated between the anode substrate and the cathode substrate;
wherein each layer in the multilayer electrolyte ranges from 1.0 μm to 30 μm and is evenly distributed.
